(19) United States
(12) Patent Application Publication
(10) Pub. No.: US 2019/0344966 A1
(43) Pub. Date: Nov. 14, 2019

(54) INSTRUCTION DEVICE AND SORTING SYSTEM

(71) Applicant: OKURA YUSOKI KABUSHIKI KAISHA, Hyogo (JP)

(72) Inventors: Hironori ISHII, Hyogo (JP); Shuji TODOROKI, Hyogo (JP); Junichi FUJIMOTO, Hyogo (JP)

(73) Assignee: OKURA YUSOKI KABUSHIKI KAISHA, Hyogo (JP)

(21) Appl. No.: 16/074,381

(22) PCT Filed: Jan. 30, 2017
(86) PCT No.: PCT/JP2017/003229

§ 371 Date: Jul. 31, 2018

(30) Foreign Application Priority Data
Feb. 1, 2016 (JP) 2016-016960

(51) Int. Cl. B65G 1/137; G06Q 10/08; H05B 37/02; F21V 14/02; F21V 21/30

(52) U.S. Cl. CPC B65G 1/1373; G06Q 10/087; B65G 2209/04; F21V 14/02; F21V 21/30; H05B 37/029

(57) ABSTRACT

To provide an instruction device and a sorting system capable of contributing to increase in working efficiency. An instruction device of a sorting system includes an illumination means device that illuminates light and an angle adjusting mechanism that moves the illumination means device. In addition, the instruction device includes a control means part that controls the illumination means device and the angle adjusting mechanism. The illumination means device formed of a spotlight draws a light path to a container as a next illumination position based on control by the control means part.

### CROSS-REFERENCE TO RELATED APPLICATIONS

This is a U.S. national phase application under 35 U.S.C. § 371 of International Patent Application No. PCT/JP2017/003229, filed Feb. 1, 2016, and claims benefit of priority to Japanese Patent Application No. 2016-016960, filed Feb. 1, 2016. The entire contents of these applications are hereby incorporated by reference.

### FIELD OF TECHNOLOGY

The present invention relates to an instruction device and a sorting system capable of contributing to increase in working efficiency.

### BACKGROUND

For example, an instruction device described in Japanese Laid-open Patent Publication No. 7-309409 is known as an instruction device that instructs a worker on a working target by light illumination on an illumination position corresponding to the working target.

This conventional instruction device includes illumination means (spotlight) that illuminates light, an angle adjusting mechanism that moves the illumination means, and control means that controls the illumination means and the angle adjusting mechanism.

Then when work on one working target is completed and work is to be done on a different next working target, the illumination means moves an illumination direction from a position corresponding to one illumination position to a position corresponding to a different illumination position. After the movement, the illumination means starts illumination to instruct a worker on the different illumination position to be subjected to work next.

### SUMMARY

Hence, if the one illumination position and the different next illumination position are at a long distance, or if multiple working targets are instructed at random, for example, the worker takes time in finding light illuminated on the different illumination position to be subjected to work next, causing the risk of decreased working efficiency.

The present invention has been made in view of such circumstances and is intended to provide an instruction device and a sorting system capable of contributing to increase in working efficiency.

An instruction device described in claim 1 is an instruction device that instructs a worker on one storage space as a working target by light illumination. The one storage space belongs to multiple storage spaces set within a predetermined range. The instruction device includes: an illumination device that illuminates light; an angle adjusting mechanism that changes the posture of the illumination device; and a control part that controls the illumination device and the angle adjusting mechanism. The control part includes a storage portion storing an operation objective for the angle adjusting mechanism for realizing the posture of the illumination device corresponding to each of the storage spaces. The control part makes the illumination device start light illumination before the operation of the angle adjusting mechanism to attain the operation objective is completed.

According to an instruction device described in claim 2, in the instruction device described in claim 1, when a working target is changed from the one storage space to a different storage space, the control part starts the operation of the angle adjusting mechanism for switching from an operation objective at the one storage space to an operation objective at the different storage space, and makes the illumination device start light illumination before the operation of the angle adjusting mechanism is completed.

According to an instruction device described in claim 3, in the instruction device described in claim 1, the storage portion stores an operation objective as a reference target for the angle adjusting mechanism corresponding a reference posture as one posture of the illumination device. The control part operates the angle adjusting mechanism to attain the reference target after work targeted to the one storage space by the worker is finished.

According to an instruction device described in claim 4, in the instruction device described in claim 3, the illumination position of light illuminated from the illumination device in the reference posture is a position having no correspondence to any storage space.

According to an instruction device described in claim 5, in the instruction device described in any one of claims 2 to 4, the control part makes the illumination device start light illumination in a period before start of the operation and immediately after start of the operation of the angle adjusting mechanism to attain the operation objective at the different storage space.

According to an instruction device described in claim 6, in the instruction device described in any one of claims 1 to 5, after the operation of the angle adjusting mechanism to attain the operation objective is completed, the control part operates the angle adjusting mechanism continuously so as to change the illumination direction of light from the illumination device continuously within a predetermined range while making the illumination device illuminate the light.

According to an instruction device described in claim 7, in the instruction device described in claim 6, the storage portion stores multiple operation objectives for the angle adjusting mechanism to be attained at the one storage space and operation order for the multiple operation objectives. After the operation of the angle adjusting mechanism to attain the operation objective is completed, the control part operates the angle adjusting mechanism so as to pass the multiple operation objectives by following the operation order while making the illumination device illuminate light.

A sorting system described in claim 8 includes the instruction device described in any one of claims 1 to 7.

A sorting system described in claim 9 is a sorting system that instructs a worker on a working target by light illumination. The sorting system includes a projection device that illuminates light, and a control part that controls the projection device. The control part controls the projection device so as to draw a path of illumination light from the projection device to a position corresponding to the working target.

A sorting system described in claim 10 is a sorting system that instructs a worker on a working target by light illumination. The sorting system includes: multiple working positions for introduction work or taking-out work of an item by the worker; a projection device that illuminates light; and a control part that controls the projection device. The control part controls the projection device so as to move illumination light from the projection device toward a position corresponding to a working position as a working target for guiding the worker to the position corresponding to the working position as a working target.

The present invention is capable of contributing to increase in working efficiency.

### BRIEF DESCRIPTION OF DRAWINGS

FIG. 1 is a front view of a sorting system according to an embodiment of the present invention.

FIG. 2 is a side view of the sorting system.

FIG. 3 is a front view of an illumination unit in the sorting system.

FIG. 4 is a side view of the illumination unit.

FIG. 5 is a plan view of the illumination unit.

FIG. 6 is an outline configuration view of the sorting system.

FIG. 7 is a flowchart for the sorting system.

FIG. 8 is a front view of display means in the sorting system.

FIGS. 9A, 9B, 9C and 9D are explanatory views of the sorting system (first pattern of light path).

FIGS. 10A, 10B and 10C are explanatory views of the sorting system (second pattern of light path).

FIGS. 11A, 11B, 11C, 11D, 11C′ and 11D′ are explanatory views of the sorting system (third pattern of light path).

FIG. 12 is an explanatory view of the sorting system (fourth pattern of light path).

FIGS. 13A, 13B, 13C and 13D are views showing patterns of movement of light within predetermined ranges.

FIGS. 14A and 14B are outline configuration views showing a modification of a projection device in the sorting system.

FIGS. 15A and 15B are outline configuration views showing a different modification of the projection device in the sorting system.

FIG. 16 is an outline configuration view showing a modification of the illumination unit in the sorting system.

### DETAILED DESCRIPTION OF EMBODIMENTS

An embodiment of the present invention will be described by referring to the drawings.

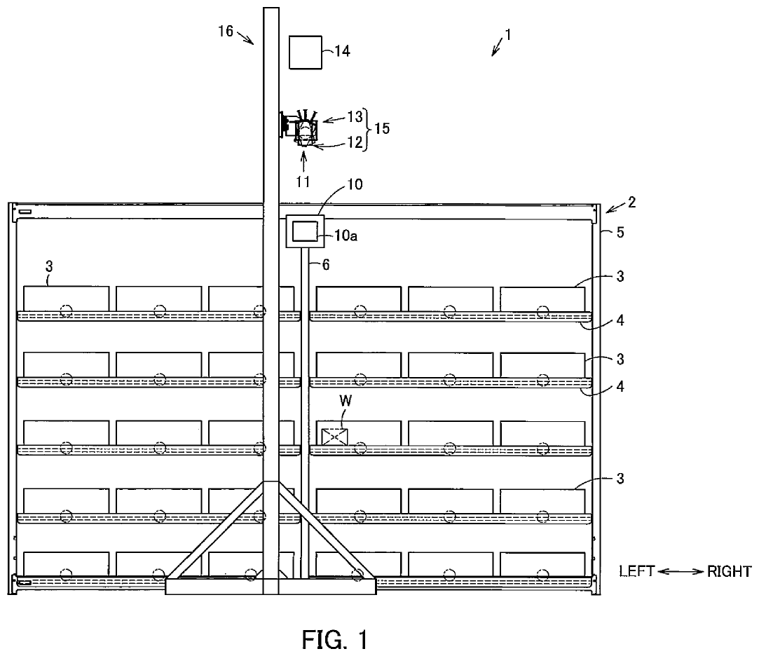

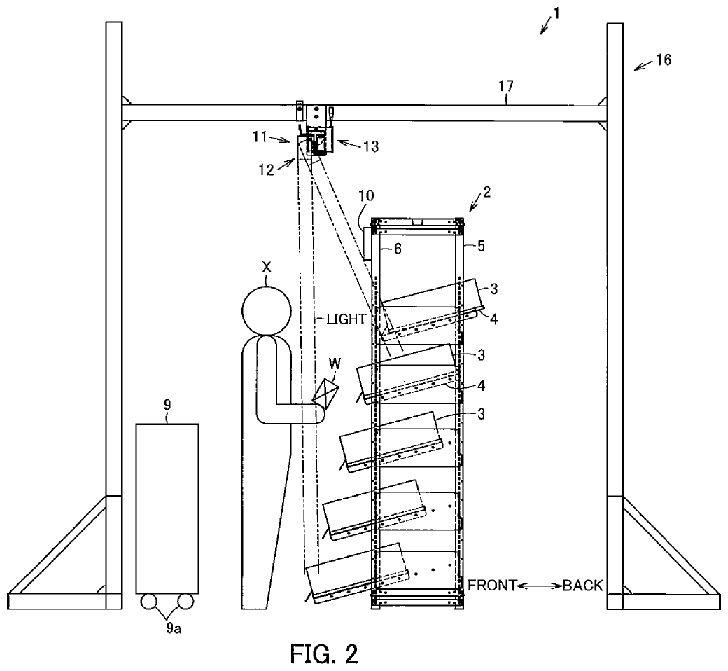

In FIGS. 1 and 2, a sorting system is denoted by 1. The sorting system 1 includes a housing rack 2 to house items W as multiple products.

Multiple containers 3 are placed in a matrix (five lines and six rows, for example) in the housing rack 2. The container 3 is an item housing part (opening) in which the item W is housed so as to be capable of being taking in and out of the container 3. The container 3 is a box-like container having an open upper side and is placed on a rack section 4 of the housing rack 2. It is noted that the container 3 may be a dished tray, for example.

In addition, multiple storage spaces to become targets of sorting work are set in the housing rack 2. Referring to FIG. 1, 30 storage spaces in total in five lines and six rows for sorting work are set in the housing rack 2. Each container 3 is placed in a corresponding predetermined storage space, thereby placing 30 containers 3 in total inside the housing rack 2. Here, each storage space is set by dividing space in the housing rack 2 within a predetermined range into multiple sections. However, the predetermined range is not limited to a range in the housing rack 2 but may be a predetermined range on a conveyor on which the container 3 is placed, for example. Alternatively, each container 3 itself placed in the housing rack 2 may be set as a storage space.

The housing rack 2 includes a frame section 5 to which rack sections 4 in multiple tiers are attached fixedly. Display means (display unit) 10 with a liquid-crystal touch panel display section 10a is attached to the frame section 5. More specifically, the frame section 5 includes a support column 6 located at a front central position of the housing rack 2 in the right-left direction and extending lengthwise in the top-down direction. The display means 10 is attached to an upper end portion of the support column 6. Specifically, the display means 10 is provided adjacent to the upper end of the front central position of the housing rack 2 in the right-left direction.

In addition, the sorting system 1 includes an instruction device 11 that instructs a worker (secondary picker) X on a container 3 to be subjected to work (work of housing an item W) next by illuminating light on the container 3 in a storage space.

It is noted that in this embodiment, light from the instruction device 11 is illuminated on the container 3 in a storage space for specifying the storage space as a working target. A lateral side of the container 3 functions as an illumination position to receive light illumination. Alternatively an illumination position may be the container 3 itself or a position near the container 3. Furthermore, also in a case where each container 3 in the housing rack 2 is set as a storage space, an illumination position may be the container 3 itself or a position near the container 3.

Thus, the worker responsible for secondary sorting work (secondary picker) X houses (introduces) an item W collected in a collection cart 9 as collection means by a worker responsible for primary sorting work in a previous step (primary picker) into a container 3 instructed by the instruction device 11 by light illumination.

It is noted that based on a primary picking list such as an order list, the worker (primary picker) not shown in the drawings collects all items W on the list in the collection cart 9, and then holds the collection cart 9 at a collection cart stop position set near the housing rack 2. In FIG. 2, the stop position for the collection cart 9 is a front central position of the housing rack 2 in the right-left direction, which is a position facing the front side of the housing rack 2 across a sorting work space for the worker (secondary picker) X prepared on the front side of the housing rack 2. It is noted that the collection cart 9 has traveling wheels 9a capable of traveling on a floor surface.

The instruction device 11 includes illumination means 12 that illuminates light as visual light for instruction, an angle adjusting mechanism 13 that adjusts the posture of the illumination means 12 to change a light illumination position (illumination direction of light from the illumination means 12) to be displayed toward the housing rack 2, and control means 14 that controls the operations of the illumination means 12, the angle adjusting mechanism 13, and the display means 10.

In addition, the illumination means 12 and the angle adjusting mechanism 13 form an illumination unit (projection device) 15 as one unit. The illumination unit 15 is attached to a support section 17 provided at an upper portion of a support frame 16 and extending lengthwise in the front-back direction so as to be adjustable in terms of a front-back position. It is noted that the illumination means 12 of the illumination unit 15 is located above (directly above) the display means 10 in a front view (see FIG. 1).

Then, based on control by the control means 14, the illumination means 12 and the angle adjusting mechanism 13 illuminate light on an illumination position set for each storage space to instruct a next container 3 to be subjected to work next by the worker X. When a working target is changed from one storage space to a different storage space, the angle adjusting mechanism 13 changes the posture of the illumination means 12 to change the illumination direction of illumination light so as to illuminate an illumination position corresponding to the different storage space with the light. Then, for this change in the illumination direction, the control means 14 starts light illumination (lighting) by the illumination means 12 before posture change of the illumination means 12 so as to point the illumination means 12 toward the illumination position corresponding to the storage space as a next working target is finished (before the operation of the angle adjusting mechanism 13 is completed). In other words, the control means 14 controls the illumination means 12 and the angle adjusting mechanism 13 so as to draw a light path to a next container 3. It is noted that the lighting includes flashing.

Here, the illumination means 12 includes a light source part. The light source part is formed of a light-emitting diode (LED) or a semiconductor laser (LD), for example. The illumination means 12 is configured as a spotlight that illuminates light (spotlight) on an illumination position through lighting of the light source part. It is noted that in this embodiment, an LED light source is used.

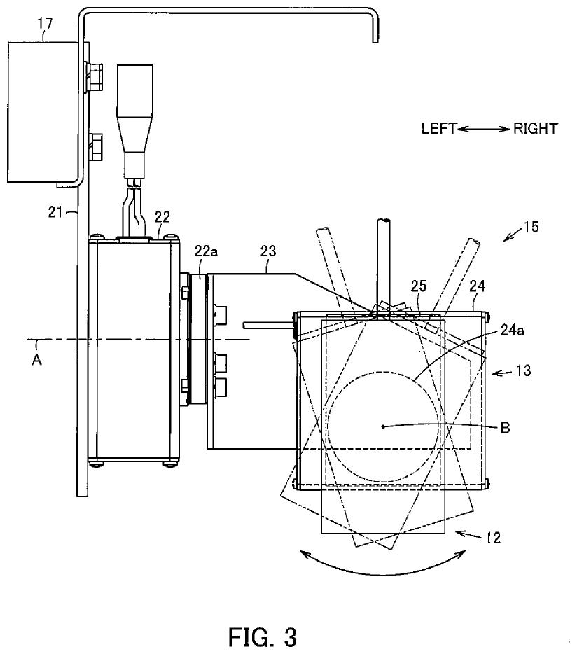

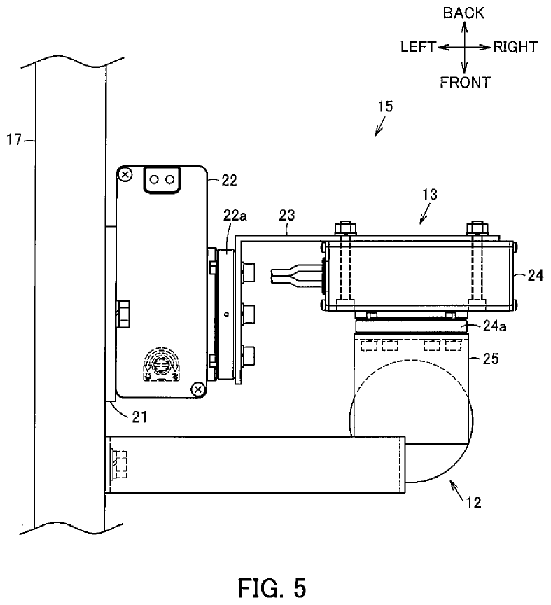

As shown in FIGS. 3 to 5, for example, the posture of the illumination means (spotlight) 12 (illumination direction) is held by the angle adjusting mechanism (direction adjusting means) 13. The angle adjusting mechanism 13 is attached to the support section 17 of the support frame 16.

The angle adjusting mechanism 13 includes a first attachment plate 21 attached to the support section 17 of the support frame 16 so as to be adjustable in terms of a front-back position. A first drive body 22 is attached to the first attachment plate 21.

The first drive body 22 includes a rotary section 22a like a circular disc to rotate about a rotary center axis line (first rotary center axis line) A in the right-left direction. Then a second attachment plate 23 is attached to the rotary section 22a of the first drive body 22. A second drive body 24 is attached to the second attachment plate 23.

The second drive body 24 includes a rotary section 24a like a circular disc to rotate about a rotary center axis line (second rotary center axis line) B in the front-back direction. Then, a third attachment plate 25 is attached to the rotary section 24a of the second drive body 24. One illumination means 12 is attached to the third attachment plate 25.

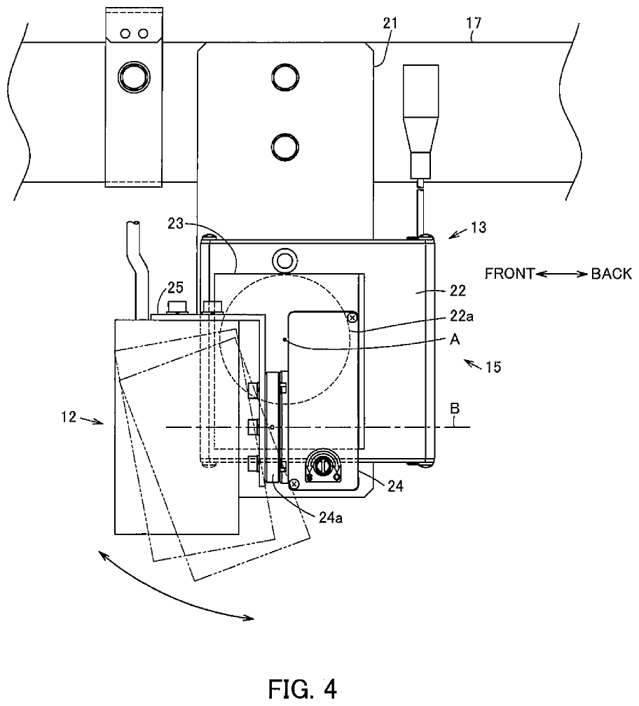

Then, the illumination means 12 rotates in the front-back direction about the rotary center axis line A based on the rotation of the rotary section 22a of the first drive body 22 (see FIG. 4). The illumination means 12 rotates in the right-left direction about the rotary center axis line B based on the rotation of the rotary section 24a of the second drive body 24 (see FIG. 3).

It is noted that each of the first drive body 22 and the second drive body 24 is formed using an electrically-driven rotary table with a built-in drive source formed of a motor, for example. The operations of the first drive body 22 and the second drive body 24 such as a rotation amount (rotation angle) and a rotation speed are controlled in response to a control signal from the control means 14.

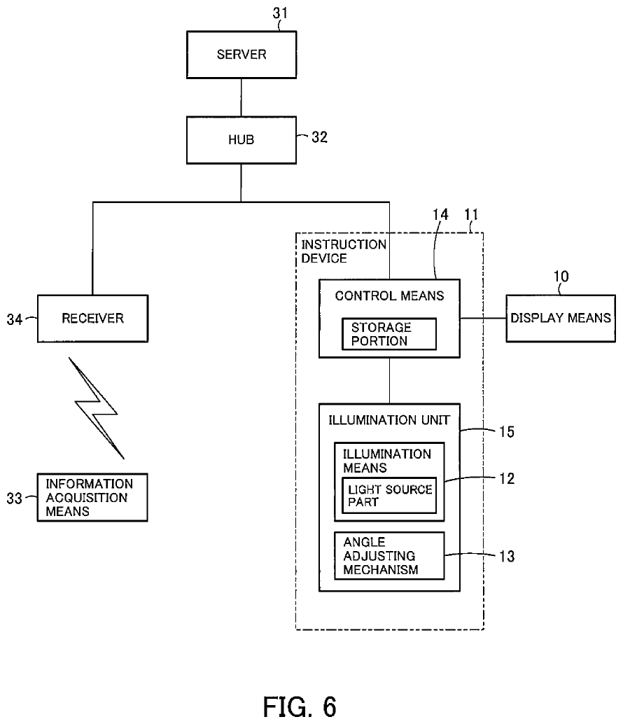

Furthermore as shown in FIG. 6, the sorting system 1 includes a server (PC) 31. A hub 32 is connected to the server 31. The control means (PLC) 14 that controls the operation of the illumination unit 15 is connected to the hub 32. And, in addition to the display means 10, the LED light source (light source part) of the illumination means 12 of the illumination unit 15 and the respective drive sources of the two drive bodies 22 and 24 of the angle adjusting mechanism 13 are connected to the control means 14. In addition, the control means 14 includes a storage portion storing operation information (operation program) about the operations of the illumination means 12, the angle adjusting mechanism 13, and the display means 10. It is noted that the storage portion may be provided either inside or outside the control means 14.

A Bluetooth (registered trademark) hub 34 is connected to the hub 32. The Bluetooth hub 34 is a receiver that receives information from a barcode reader (BCR) 33 as information acquisition means that acquires information from an identifier. It is noted that a barcode (BCD) as an identifier is assigned to each of an item W, a container 3, and the primary picking list.

The following describes the action, etc. of the sorting system 1 described above.

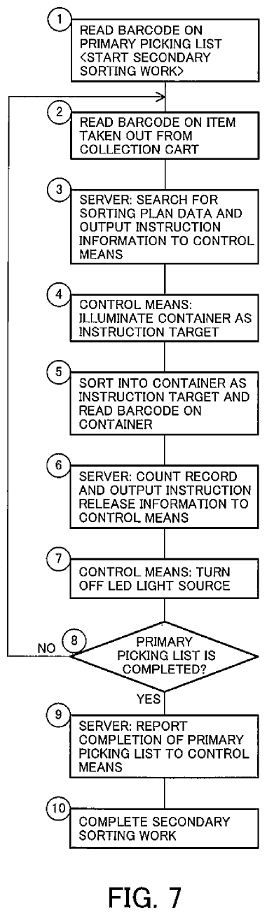

A flow of sorting process by the sorting system 1 will be described first based on the flowchart in FIG. 7.

The collection cart 9 housing items W on the primary picking list at random is placed at the collection cart stop position ahead of the housing rack 2 by a worker (primary picker).

Next, a worker (secondary picker) X reads a barcode attached to the collection cart 9 staying at the collection cart stop position or a barcode on the primary picking list linked with the collection cart 9 using the barcode reader 33 (step 1).

Then, the server 31 assigns sorting work information (order information, for example) corresponding to the primary picking list to each storage space in the housing rack 2. After receiving the primary picking list, the server 31 assigns sorting work to a storage space of high priority set in advance for increasing working efficiency in decreasing order of work load (the number of sorting works, the number of lines, and the number of items, for example).

Next, the worker X takes out one item W, for example, from the collection cart 9 located at the collection cart stop position, and reads a barcode on the item W taken out using the barcode reader 33, thereby acquiring item information (step 2).

Then, based on the item information about the item W taken out, the server 31 searches for sorting plan data containing unsorted item information from the sorting work information, specifies a storage space requested to accept introduction of this item W, and outputs instruction information to the control means 14 (step 3).

Based on the instruction information, the control means 14 controls the illumination means 12, the angle adjusting mechanism 13, and the display means 10 to light the LED light source, thereby illuminating light on a container 3 as an instruction target in which the item W is to be housed by the worker X (step 4). It is noted that a particular method of the illumination based on control by the control means 14 will be described later.

Next, the worker X houses and sorts the item W taken out from the collection cart 9 into the container 3 as an instruction target instructed by the light illumination by the illumination means 12. Then, the worker X acquires container information by reading a barcode on the container 3 in which this item W is housed using the barcode reader 33 (step 5).

Then, if the read container information about the container 3 matches container information about the container 3 placed in the storage space as an instruction target, the server 31 counts a sorting record and outputs instruction release information to the control means 14 (step 6). Meanwhile, if the read container information about the container 3 does not match the container 3 in the storage space as an instruction target, an “Unacceptable indication” is displayed on the touch panel display section 10a as a display section of the display means 10. It is noted that association between container information about the container 3 placed in each storage space and each storage space is managed in advance by the server 31.

The control means 14 controls the illumination means 12 based on the instruction release information to make the illumination means 12 turn off the LED light source (step 7).

Next, the server 31 determines whether or not housing work (introduction work) into containers 3 as instruction targets has been completed for all the items W in the collection cart 9 listed on the primary picking list (step 8).

If the server 31 determines that the housing work has been completed, the server 31 notifies the control means 14 of completion of sorting of all the items W on the primary picking list (step 9). It is noted that, if the housing work has not been completed, the flow returns to step 2 described above.

When the control means 14 receives the notification of completion of sorting, the secondary sorting work by the worker X is completed for all the items W on the primary picking list (step 10).

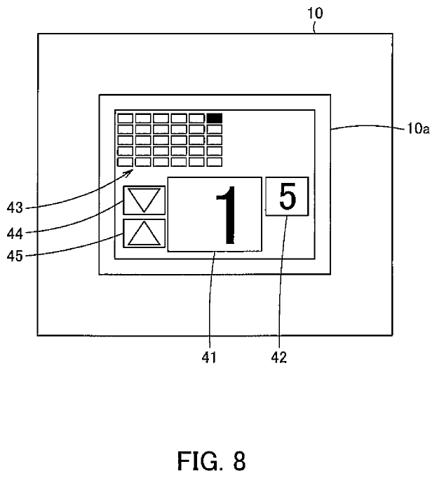

Next, FIG. 8 shows an example of a working screen displayed on the touch panel display section 10a of the display means 10.

This working screen includes a pick count display area 41 for display of a pick count (“1,” for example) about an item W to be taken out from the collection cart 9, and a planned count display area 42 for display of a residual planned count (“5,” for example) about the item W to be housed in a container 3 as an instruction target.

In addition, this working screen further includes multiple graphic objects displayed in a matrix corresponding to multiple containers 3 in the housing rack 2 (graphic objects displayed in five lines and three columns and located on each of the right side and left side, for example), and an instruction target display area 43 in which only one graphic object corresponding to one container 3 as an instruction target is displayed in a different format, for example, in a different color from the other multiple graphic objects. It is noted that the working screen on the display means 10 is not limited to the foregoing example but may have a configuration where an indication in five lines and three columns indicating the right half of the housing rack 2 is displayed as graphic objects corresponding to multiple containers 3 in the housing rack 2 in an upper left area of the working screen, an indication in five lines and three columns indicating the left half of the housing rack 2 is displayed as graphic objects corresponding to multiple containers 3 in the housing rack 2 in an upper right area of the working screen, and an operation menu button, a number corresponding to one container 3 as an instruction target, etc. are displayed between these indications in five lines and three columns, for example.

This working screen further includes a pick count change button for changing a pick count displayed in the pick count display area 41, specifically, a reduction button 44 and an increase button 45, for example.

Then, if multiple products W of the same type as a product W for which product information has been acquired by the worker X by being taken out from the collection cart 9 are required to be sorted into one container 3, and if the number of the products W of the same type to be sorted into the one container 3 is “five,” for example, a total sorting count “5” is displayed in the planned count display area 42 and “1” showing an initial state is displayed in the pick count display area 41. In this case, if the worker X intends to process the five products together, the worker X can change a pick count displayed in the pick count display area 41 to “5” indicating a residual planned count by touching the increase button 45, for example. Then, the worker X can house and sort the five items W of the same type together into the one container 3 as an instruction target. It is noted that an indication in the pick count display area 41 is changeable to any count within the range of a planned count displayed in the planned count display area 42. In the foregoing case, this allows flexible work such as sorting the items one by one, sorting the five items together, or sorting only three of these items first as these three items can be found at easily recognizable positions in the collection cart 9, for example.

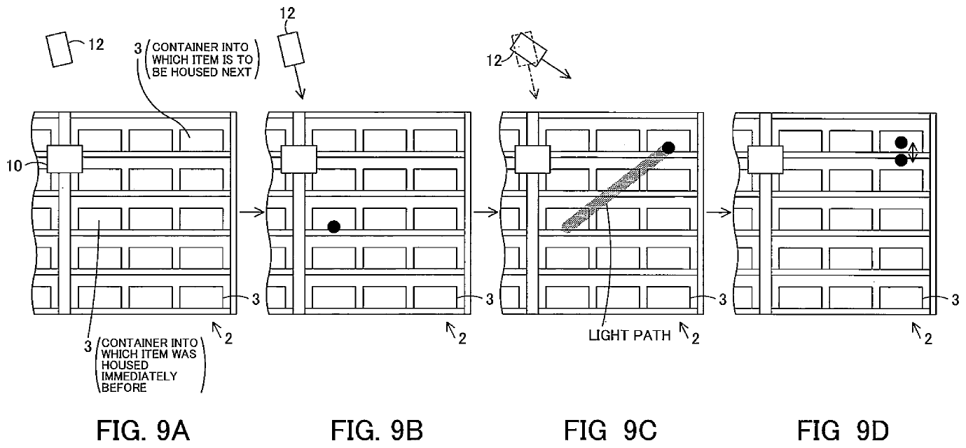

Particular illumination methods based on control by the control means 14 of the instruction device 11 will be described next by referring to FIGS. 9A, 9B, 9C and 9D to 13A, 13B, 13C and 13D.

The storage portion of the control means 14 stores at least one illumination position set in advance for each storage space. The storage portion stores an operation objective (rotation angle about each axis) for the angle adjusting mechanism 13 for pointing the light source part of the illumination means 12 toward an illumination direction responsive to each illumination position corresponding to each storage space and realizing the posture of the illumination means 12 responsive to the storage space. It is noted that, if multiple illumination positions are set for a storage space, one of these illumination positions can be set as an operation objective for changing the posture of the illumination means 12. In addition, a predetermined range other than a point may be set as an illumination position.

Firstly, FIG. 9A, 9B, 9C and 9D show an example where, during movement of the illumination means 12 from a position corresponding to immediately preceding one container 3 where work (work of housing an item W) has been completed (a position indicated by alternate long and two short dashes lines in FIG. 9C and will be called a “previous position”) to a position corresponding to a different next container 3 to be subjected to work next (a position indicated by solid lines in FIG. 9C and will be called a “next position”), the LED light source is lighted to start illumination before arrival at the next position.

More specifically, when the worker X first houses an item W into the one container 3 as an immediately preceding instruction target and reads a barcode on this container 3 using the barcode reader 33, work of sorting this item W is determined to be completed. Then, as shown in FIG. 9A, the illumination means 12 turns off the LED light source.

Next, when the worker X takes out an item W from the collection cart 9 and reads a barcode on this item W using the barcode reader 33, information about the item W is transmitted to the server 31 and a next storage space into which this item W is to be sorted is determined. Then, in order to move the illumination means 12 to a posture for illumination of light on an illumination position set for the next storage space, the control means 14 operates the angle adjusting mechanism 13 for the next position based on an operation objective corresponding to the next storage space stored in the storage portion. More specifically, for switching from an operation objective at the previous position or at a neighboring position to an operation objective at the next position (rotation angles of the two rotary sections 22a and 24a), the rotary sections 22a and 24a in a state at the previous position are rotated by predetermined amounts.

In addition, concurrently with this operation of the angle adjusting mechanism 13, the control means 14 controls lighting operation as the operation of the illumination means 12. This operation of lighting the light source part of the illumination means 12 is started before the operation of the angle adjusting mechanism 13 to attain the operation objective at the next position is completed.

As shown in FIGS. 9B and 9C, for example, based on the operation objective at the next position stored in the storage portion, the control means 14 lights the LED light source of the illumination means 12 to coincide with start of the operation of the angle adjusting mechanism 13 from the previous position to the next position. Then, the state of lighting the light source part of the illumination means 12 (lighting state) is maintained until the posture change is finished, specifically, until the operation of the angle adjusting mechanism 13 to attain the operation objective is completed.

Specifically, while the lighting state of illuminating light toward the front side of the housing rack 2 is maintained, the posture of the illumination means 12 is changed from the previous position to the next position based on the rotations of the rotary sections 22a and 24a of the drive bodies 22 and 24 of the angle adjusting mechanism 13 by intended angles.

As a result, a light path is drawn on the front side of the housing rack 2 so as to show movement of light from an illumination position corresponding to immediately preceding one storage space to an illumination position corresponding to a different next storage space (see FIG. 9C). Thus, the worker X checks the movement of light with eyes to guide the line of sight of the worker X toward the container 3 placed in the storage space as a next working target. In this case, if the worker X directs the line of sight of the worker X to the previous position where the worker X did work immediately before in starting next operation, the worker X is guided to the next working position by the light moving from the previous position to the next position. In this way, the location of the next position is found more easily to increase working efficiency than in the case of finding a next position in the housing rack 2 at random.

In addition, after arrival at the next position corresponding to the different next container 3, in order to make the storage space as an instruction target evident, the control means 14 operates the angle adjusting mechanism 13 continuously so as to move light (light illumination position) continuously within a predetermined range set for the storage space. The predetermined range can include the container 3. It is noted that the operation of the angle adjusting mechanism 13 forms the operation of moving the light repeated continuously.

Specifically, as shown in FIG. 9D, for example, when posture change of the illumination means 12 by the angle adjusting mechanism 13 is completed and illumination light arrives at the next position, the light moves in the top-down direction between predetermined multiple set points within a predetermined range of each storage space such as two set points separated one above the other, for example, thereby emphasizing the storage space as a working target.

Specifically, multiple illumination positions are set for each storage space. Additionally, operation objectives for the angle adjusting mechanism 13 corresponding to the multiple illumination positions are stored in the storage portion. Illumination order showing the order of illuminating multiple illumination positions for each storage space is further stored in the storage portion as operation order of the angle adjusting mechanism 13. After the operation of the angle adjusting mechanism 13 for the storage space as a next working target is completed, the control means 14 operates the rotary sections 22a and 24a of the angle adjusting mechanism 13 while maintaining lighting of the illumination means 12. The operations of the rotary sections 22a and 24a of the angle adjusting mechanism 13 are performed so as to pass the operation objectives set for the storage space as a working target sequentially by following the operation order. A series of these operations is performed repeatedly.

By the action of the angle adjusting mechanism 13, the posture of the illumination means 12 is changed while the lighting state is maintained. Thus, from the viewpoint of the worker X, the light illuminated from the illumination means 12 is visually recognized as light moving within the predetermined range. In the presence of this movement of light, even if the worker X loses sight of the path of the illumination position of light to move to a next storage space, the storage space as a working target is emphasized by the light moving repeatedly within the predetermined range. In this way, the worker X is allowed to easily find the different next container 3 as a next instruction target.

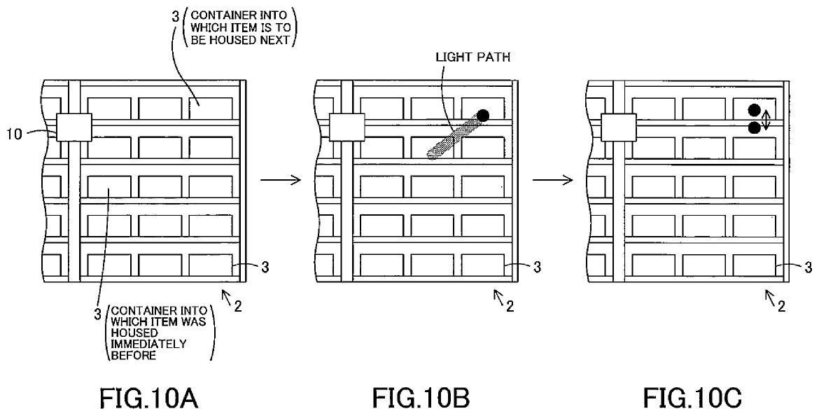

It is noted that in the foregoing example shown in FIG. 9A, 9B, 9C and 9D, the control means 14 starts light illumination in a period from start of operation of posture change when the illumination means 12 is in the previous position (start of the operation of the angle adjusting mechanism 13) to before completion of the operation of posture change when the illumination means 12 is in the next position (before finish of the operation of the angle adjusting mechanism 13), specifically, at the start of changing the posture of the illumination means 12 from the previous position to the next position. Alternatively, as shown in FIGS. 10A, 10B and 10C, for example, light illumination may be started before arrival at the next position, specifically, while the posture is being changed from the previous position to the next position and before the posture change is completed.

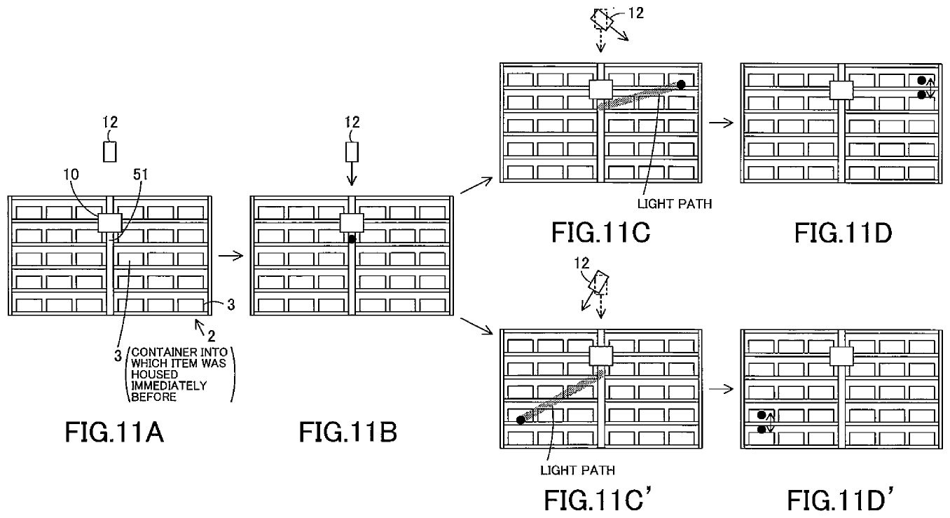

Then, FIGS. 11A, 11B, 11C, 11D, 11C′ and 11D′ show an example where, during movement of the illumination means 12 from a predetermined reference posture (a position indicated by alternate long and two short dashes lines in FIGS. 11C and 11C′) to a posture corresponding to a next storage space to be subjected to work next (a position indicated by solid lines in FIGS. 11C and 11C′ and will be called a “next position”), the LED light source is lighted to start illumination before arrival at the next position. Here, Light from the illumination means 12 in the reference posture is illuminated on a reference illumination position 51 as a fixed illumination position.

In this example, each time work of housing an item W (or taking-out work) into or from a container 3 placed in each storage space is completed, the posture of the illumination means 12 returns to the reference posture (movement start position) corresponding to the reference illumination position 51. Specifically, an operation objective for the angle adjusting mechanism 13 for placing the illumination means 12 in the reference posture is stored as a reference target in the storage portion. If a worker finishes work targeted to one storage space, the control means 14 operates the angle adjusting mechanism 13 to attain the reference target. It is noted that the reference illumination position 51 is a position near the display means 10 located at the front central position of the housing rack 2 in the right-left direction, specifically, a position below and near the display means 10 on the front side of the support column 6 of the housing rack 2. The reference illumination position 51 has no correspondence to any storage space and is not a position for instructing any storage space or any container 3 placed in a storage space. It is noted that in principle, only one reference illumination position 51 is set in a working zone including multiple storage spaces in the housing rack 2 or the sorting system 1 assigned to and handled by one worker.

More specifically, when the worker X first houses an item W into one container 3 as an immediately preceding instruction target and reads a barcode on this container 3 using the barcode reader 33, the control means 14 turns off the LED light source of the illumination means 12 and operates the angle adjusting mechanism 13 to attain the reference target, as shown in FIG. 11A. By doing so, the posture of the illumination means 12 is returned to the reference posture.

Next, the worker X takes out an item W from the collection cart 9, and reads a barcode on this item W using the barcode reader 33. Then, a storage space as a next working target corresponding to the read item W is determined by the server 31 as a next position. After the next position is determined, the control means 14 starts the operation of the angle adjusting mechanism 13 to attain an operation objective at the next position. Immediately before (including time several seconds before) start of the operation of the angle adjusting mechanism 13, simultaneously with start of the operation, or during the operation, the control means 14 lights the light source of the illumination means 12. As shown in FIGS. 11B and 11C, for example, the LED light source is lighted at the start of changing the posture of the illumination means 12 to the next position. While the state of lighting the LED light source (lighting state) is maintained, the illumination means 12 is tilted from the reference posture toward a rightward direction of the housing rack 2. In this way, the posture of the illumination means 12 is changed to a posture corresponding to the next storage space.

Specifically, if the next position is on the right side of the housing rack 2, the illumination means 12 moves from the reference posture to the next position on the right side of the housing rack 2 based on the rotations of the rotary sections 22a and 24a of the drive bodies 22 and 24 of the angle adjusting mechanism 13 by intended angles while the lighting state of illuminating light (red light, for example) toward the front side of the housing rack 2 is maintained. Then, the operation of the angle adjusting mechanism 13 to attain the operation objective at the next position is completed.

As a result, a light path from the reference illumination position 51 to the next container 3, specifically, a path of the illumination position of red light, for example, is drawn on the front side of the housing rack 2 (see FIG. 11C). In this way, the line of sight of the worker X is guided to the next container 3. In this case, the worker X checks the reference illumination position 51 at a fixed position with eyes when the worker X starts next work to guide the line of sight of the worker X with light moving from the reference illumination position 51 to the next position. In this way, the location of the next position is found more easily to increase working efficiency than in the case of finding a next position in the housing rack 2 at random. Further, the reference illumination position 51 is a fixed position, so that the worker X is not required to perform operation of moving the line of sight of the worker X to the illumination position at the previous position after acquiring product information. Additionally, the reference illumination position 51 is set near the center of the housing rack 2. This eliminates the risk of decreasing working efficiency to be caused by a long light path presented to the worker X if a position change from the previous position to the next position is from the right end to the left end of the housing rack 2, for example.

In addition, after arrival at the next position corresponding to the next storage space, the illumination means 12 repeats predetermined operation so as to move light (light illumination position) within a predetermined range including the position of the storage space as an instruction target.

Specifically, as shown in FIG. 11D, for example, on the arrival at the next position, the illumination means 12 repeats predetermined oscillating motion based on the rotations of the rotary sections 22a and 24a of the angle adjusting mechanism 13 so as to move red light, for example, in the top-down direction between predetermined multiple set points within a predetermined range of each storage space such as two set points separated one above the other. By doing so, even if the worker X loses sight of the path of the illumination position of light, the worker X is still allowed to easily find the next storage space as a next instruction target.

It is noted that, if the next container 3 is on the left side of the housing rack 2, the illumination means 12 moves from the set position to the next position on the left side of the housing rack 2 while the lighting state of illuminating light (green light, for example) toward the front side of the housing rack 2 is maintained. As a result, a light path from the reference illumination position 51 to the next storage space, specifically, a path of the illumination position of green light, for example, is drawn on the front side of the housing rack 2 (see FIG. 11C′). Then, light of green color, for example, moves in the top-down direction within the predetermined range (see FIG. 11D′). In this way, different colors are used between light illuminated from the illumination means 12 to the right side of the housing rack 2 and light illuminated from the illumination means 12 to the left side of the housing rack 2. As a result, the worker X easily determines which one of the right region and the left region is a region including a working target.

In addition, in the foregoing example shown in FIGS. 11A, 11B, 11C, 11D, 11C′ and 11D′, the illumination means 12 starts illumination before arrival at the next position, specifically, at the start of movement from the set position to the next position. Alternatively, like in the case shown in FIGS. 10A, 10B and 10C, for example, illumination may be started before arrival at the next position, specifically, during movement from the previous position to the next position.

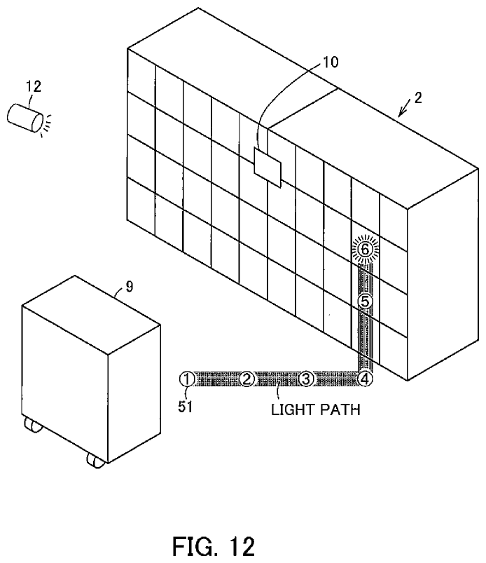

Furthermore, in the foregoing example shown in FIGS. 11A, 11B, 11C, 11D, 11C′ and 11D′, the reference illumination position 51 is set at a position near the display means 10. Alternatively, the reference illumination position 51 may be set on a floor surface. After the worker X finishes one sorting work, for example, the worker X goes to the collection cart 9, takes out a product from the collection cart 9, and reads a barcode on the item W taken out from the collection cart 9 in preparation for next work. The worker X generally reads the barcode with the line of sight of the worker X being pointed downwardly. Thus, as shown in FIG. 12, for example, the reference illumination position 51 may be set at a position near the collection cart 9 stopping at the collection cart stop position and being located ahead of the central position of the housing rack 2 in the right-left direction, for example, specifically, at a position on the floor surface on which the collection cart 9 is to travel and near the collection cart stop position.

In this case, light illuminated from the illumination means 12 first moves on the floor surface from the reference illumination position 51 set on the floor surface to a position below a column in the housing rack 2 including a storage space as a next working target to instruct a column position in the housing rack 2. Then, the light moves upwardly to instruct this storage space. In other words, a light path from the reference illumination position 51 to the next storage space is drawn so as to extend from the floor surface near the collection cart 9 toward the front side of the housing rack 2.

Then, a worker generally reads a barcode on an item W with the line of sight of the worker being pointed downwardly. Thus, the worker is allowed to check the reference illumination position 51 with eyes while pointing the line of sight of the worker downwardly continuously from the operation of reading the barcode. In this state, the worker is guided by the light to the location of the next position. In this way, the location of the next position is found more easily to increase working efficiency than in the case of finding a next position in the housing rack 2 at random.

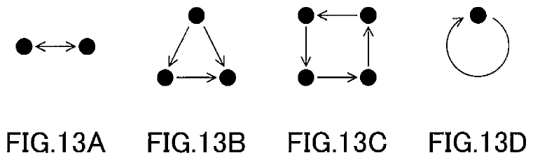

It is noted that in each of the foregoing examples, illumination positions set for forming a movement pattern of light for emphasizing a working target space within a predetermined range set in advance for each storage space are not limited to two set points separated one above the other. The number of set points may be determined arbitrarily. For example, set points may be two points separated to the right and left shown in FIG. 13A, three points forming a triangle shown in FIG. 13B, four points forming a rectangle showing in FIG. 13C, or multiple points forming a circle shown in FIG. 13D. In addition, order of illuminating multiple illumination positions may be determined in such a manner that the multiple points are illuminated in a one-stroke pattern. Alternatively, the multiple points may be illuminated in arbitrarily determined order.

Then, according to the sorting system 1 described above, based on control over the LED light source of the illumination means 12 and the drive sources of the drive bodies 22 and 24 of the angle adjusting mechanism 13 by the control means 14, the illumination means 12 draws a light path from an intended path beginning position to the position of a next container 3 (path terminal position) where the worker X is to do work next as preparatory operation. Thus, the worker X checks this path with eyes to guide the line of sight of the worker X toward the next container 3. Accordingly, this allows the worker X to easily find the next container 3 as an instruction target, thereby contributing to increase in working efficiency.

In addition, after arrival at a position corresponding to the next container 3 as an instruction target, the illumination means 12 repeats predetermined operation so as to move light within a predetermined range near the instruction target. Thus, even if the worker X loses sight of a light path, the worker X can still find the next container 3 as an instruction target easily with the light moving repeatedly and continuously, thereby contributing to increase in working efficiency. It is noted that, even if there is variation in the tilt or position between the containers 3 resulting from the configuration of the housing rack 2, for example, the worker X is still allowed to specify the container 3 as an instruction target by moving light within the predetermined range responsive to the next container 3 as an instruction target.

It is noted that a light path drawn by the illumination means 12 of the illumination unit 15 is not limited to a continuous path in a straight line resulting from continuous lighting of the light source part but may be a discontinuous path resulting from flashing of the light source part, for example.

In addition, a path of illumination light may be drawn by movement of the light along a predetermined route entirely or part of the route, by movement of the illumination light in a lighting state from a start position to an arrival position, or by movement of the illumination light along at least one of a fixed range after the start position and a fixed range before the arrival position. Additionally, an intermediate part of the movement route of the illumination light from the start position to the arrival position may be omitted by turning off the illumination light.

In addition, Light emitted from the light source part of the illumination means 12 may differ in color between a state where the angle adjusting mechanism 13 is stopping and a state where the angle adjusting mechanism 13 is operating. Specifically, the color of emitted light can be changed for distinctively showing whether the light is being used for instructing a working target or whether the light is moving before arriving at a working target. By doing so, the worker X is allowed to determine an operating state easily.

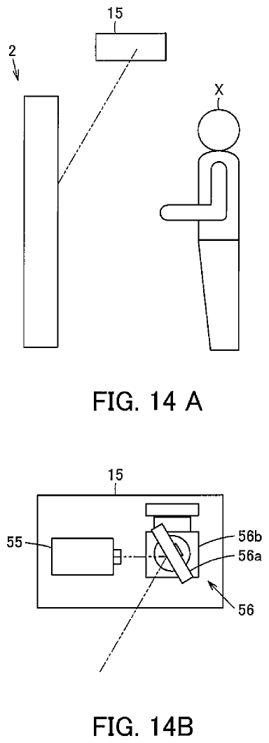

As long as the projection device (illumination unit 15) is configured to allow movement of illumination light, the projection device is not limited to a configuration including the illumination means 12 and the angle adjusting mechanism 13. As shown in FIG. 14A and 14B, for example, the projection device may have a configuration including illumination means 55 and reflection means 56. The reflection means 56 includes a reflector 56a, and an angle adjusting mechanism 56b that adjusts the angle of the reflector 56a by rotating the reflector 56a. It is noted that the angle adjusting mechanism 56b has the same configuration as the foregoing angle adjusting mechanism 13. Then, light illuminated from the illumination means 55 is reflected on the operable reflection means 56 to adjust the illumination direction of the light. By making such adjustment of the illumination direction of the light, the movement and illumination position of the light are changed. It is noted that the illumination direction of the light may be adjusted by operating both or one of the illumination means 55 and the reflection means 56.

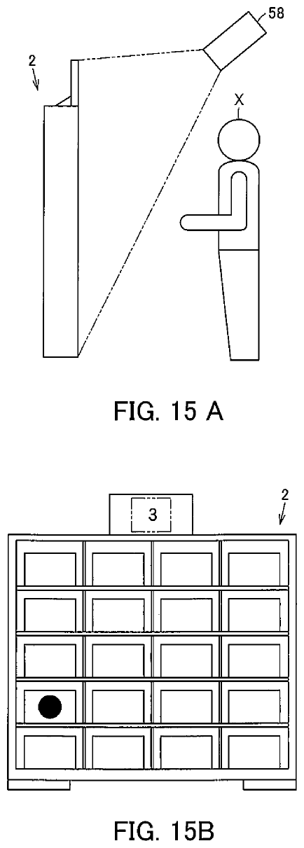

In addition, as shown in FIG. 15A and 15B, a projector 58 may be used as the projection device. In this case, multiple storage spaces may be located within the range of projection from the projector 58. Projection showing movement of an image lighted with light to a position corresponding to a storage space within the range of the projection may be projected from the projector 58. An image (projection) showing work information may be displayed within the range of the projection from the projector 58, and this image may be used as display means.

In addition, the configuration with one illumination unit 15 provided for one housing rack 2 is not a limited configuration. The number of the illumination units 15 may be determined arbitrarily. Multiple illumination units 15 may be provided. By the use of multiple illumination units 15, even if illumination light from one illumination means 12 is blocked by a worker or even if one illumination means 12 is broken, for example, a working target in the housing rack 2 can still be instructed using illumination light from different illumination means 12. Even if one illumination means 12 fails to function, decrease in working efficiency is still prevented by different functional illumination means 12. In addition, if an illumination target range covers a wide range resulting from a large size of the housing rack 2 or a wide range for placement of the containers 3, for example, the illumination target range may be divided and the divided ranges may be handled by multiple illumination means 12. By doing so, illuminance reduction of illumination light or excessive deformation of the shape of illumination light can be prevented.

A storage space may be set in a plane. For example, light may be illuminated on a floor surface, a conveyor transport surface, and various types of tables. In such cases, multiple storage spaces are set in a predetermined plane range. A worker can be instructed on an introduction position (placement position) or a taking-out position of an item by movement of illumination light within this plane range.

Furthermore, the sorting system 1 is not limited to the configuration of housing and sorting an item W into a container 3 in the housing rack 2. For example, the sorting system 1 may be configured to take out an item from a storage space instructed by an illumination position in a housing rack instructed by light illumination and to sort the item taken out into a storage space instructed by an illumination position at transport means instructed by light illumination. Specifically, the sorting system 1 is applicable both to sorting works including picking and assorting, and is applicable to work of taking out a product from a container, etc. and work of introducing the product into a container, etc. during each of the sorting works.

In addition, the angle adjusting mechanism 13 may use a rotary axis line other than two axes. In the case of two axes, the direction of the first rotary center axis line and that of the second rotary center axis line may be determined by a rotary axis in the vertical direction and a rotary axis in the horizontal direction, for example.

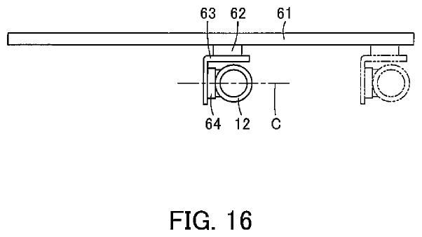

Furthermore, as shown in FIG. 16, the angle adjusting mechanism 13 may have a configuration formed by combining movement in the transverse direction along a slide guide 61 and rotation around a horizontal axis line about a rotary axis line C. In this configuration, a slide body 62 is attached movably to the slide guide 61. In addition, the illumination means 12 is attached through a drive body 64 to a bracket 63 fixed to a slide body 62 so as to be rotatable about the rotary axis line C. Then, the illumination means 12 moves in the right-left direction toward a position above a column including an illumination position along the slide guide 61 while rotating in the front-back direction about the rotary axis line C, thereby changing a light illumination direction. In this case, the light illumination direction is changed only in the longitudinal direction relative to the illumination position. This makes it unlikely that the shape of illumination light will be deformed, so that the illumination light is easily recognized visually.

It is noted that Lighting and turning off of the illumination means 12 by the control means 14 may be achieved by one of a configuration where the control means 14 switches power supply to the illumination means 12 on and off, and a configuration where the control means 14 transmits an ON signal and an OFF signal to a power supply circuit.

In addition, time of starting lighting of the light source part of the illumination means 12 is set before completion of the operation of the angle adjusting mechanism 13 to attain an operation objective. Lighting of the light source part may be started before the operation of the angle adjusting mechanism 13 is started, simultaneously with start of the operation, or after start of the operation. If lighting of the illumination means 12 is started to coincide with timing in a period from before start of the operation of the angle adjusting mechanism 13 to immediately after start of the operation, movement of light is started from a storage space where the worker X did work immediately before or a position near this storage space. In this case, the worker X easily recognizes start of motion of the light to guide the worker X more effectively.

The position of light illuminated from the illumination means 12 in the reference posture (reference illumination position) may be located in a neighborhood including the display means 10. It is noted that locating the light position in the neighborhood including the display means 10 may mean that light is illuminated entirely or partially on the display means 10 itself or light is illuminated on an area around the display means 10.

The display means 10 displays work information about work (a pick count, for example). Each time a worker is to do work, the worker checks the display means 10 for acquiring work information.

Thus, starting movement of light from the reference illumination position allow the worker to check the display means and the movement of the light for instructing a working position in doing a series of working operations. This allows the worker to understand work information and a working target corresponding to the work information efficiently, thereby increasing working efficiency.

It is noted that timing of starting movement of light from the reference illumination position may be delayed from timing of starting display of work information by the display means 10. This allows the worker to understand work information more easily.

It is noted that for the operation of the angle adjusting mechanism 13 for switching from one storage space to a difference storage space, the control means 14 operates the angle adjusting mechanism 13 by an operation load required for switching from an operation objective corresponding to the one storage space to an operation objective corresponding to the different storage space. Additionally, the control means 14 may read the operation load stored in advance in the storage portion for switching from the one storage space to the different storage space, and operate the angle adjusting mechanism 13 based on the read operation load.

The present invention is used in a sorting system for sorting an item, for example.

1. An instruction device that instructs a worker on one storage space as a working target by light illumination, the one storage space belonging to multiple storage spaces set within a predetermined range, the instruction device comprising:
an illumination device that illuminates light;
an angle adjusting mechanism that changes the posture of the illumination device; and
a control part that controls the illumination device and the angle adjusting mechanism, wherein
the control part comprises a storage portion storing an operation objective for the angle adjusting mechanism for realizing the posture of the illumination device corresponding to each of the storage spaces, and
the control part makes the illumination device start light illumination before the operation of the angle adjusting mechanism to attain the operation objective is completed.

2. The instruction device according to claim 1, wherein
when a working target is changed from the one storage space to a different storage space, the control part starts the operation of the angle adjusting mechanism for switching from an operation objective at the one storage space to an operation objective at the different storage space, and makes the illumination device start light illumination before the operation of the angle adjusting mechanism is completed.

3. The instruction device according to claim 1, wherein
the storage portion stores an operation objective as a reference target for the angle adjusting mechanism corresponding a reference posture as one posture of the illumination device, and
the control part operates the angle adjusting mechanism to attain the reference target after work targeted to the one storage space by the worker is finished.

4. The instruction device according to claim 3, wherein
the illumination position of light illuminated from the illumination device in the reference posture is a position having no correspondence to any storage space.

5. The instruction device according to claim 2, wherein
the control part makes the illumination device start light illumination in a period from before start of the operation to immediately after start of the operation of the angle adjusting mechanism to attain the operation objective at the different storage space.

6. The instruction device according to claim 1, wherein
after the operation of the angle adjusting mechanism to attain the operation objective is completed, the control part operates the angle adjusting mechanism continuously so as to change the illumination direction of light from the illumination device continuously within a predetermined range while making the illumination device illuminate the light.

7. The instruction device according to claim 7, wherein
the storage portion stores multiple operation objectives for the angle adjusting mechanism to be attained at the one storage space and operation order for the multiple operation objectives, and
after the operation of the angle adjusting mechanism to attain the operation objective is completed, the control part operates the angle adjusting mechanism so as to pass the multiple operation objectives by following the operation order while making the illumination device illuminate light.

8. (canceled)

9. A sorting system that instructs a worker on a working target by light illumination, comprising:
a projection device that illuminates light; and
a control part that controls the projection device, wherein
the control part controls the projection device so as to draw a path of illumination light from the projection device to a position corresponding to the working target.

10. A sorting system that instructs a worker on a working target by light illumination, comprising:
multiple working positions for introduction work or taking-out work of an item by the worker;
a projection device that illuminates light; and
a control part that controls the projection device, wherein the control part controls the projection device so as to move illumination light from the projection device toward a position corresponding to a working position as a working target for guiding the worker to the position corresponding to the working position as a working target.

11. The instruction device according to claim 3, wherein
the control part makes the illumination device start light illumination in a period from before start of the operation to immediately after start of the operation of the angle adjusting mechanism to attain the operation objective at the different storage space.
